(19) United States
(12) Patent Application Publication
(10) Pub. No.: US 2025/0019782 A1
(43) Pub. Date: Jan. 16, 2025

(54) Steelmaking method and associated network of plants

(71) Applicant: ArcelorMittal, Luxembourg (LU)

(72) Inventors: Dominique SERT, Montoy Flanville (FR); Patrick NEGRO, Marly (FR); Eric Alain Gabriel HESS, Metz (FR); Jean-Luc Didier REBOUL, Bouc Bel Air (FR)

(21) Appl. No.: 18/716,445

(22) PCT Filed: Dec. 16, 2021
(86) PCT No.: PCT/IB2021/061841

§ 371 Date: Jun. 4, 2024

(51) Int. Cl. C21B 5/06; C21B 7/00; C25B 1/04

(52) U.S. Cl. CPC C21B 5/06; C21B 7/002; C21B 2100/22; C25B 1/04

(57) ABSTRACT

Method to produce hot metal in at least one blast furnace (1) including at least two levels of gas injection (3A, 3B) and emitting a blast furnace top gas (10) when working, the method including at least the steps of charging an iron-containing charge (4) and a first carbon-based reductant (5) into the blast furnace, injecting at the first level (3A) a hot blast (11) having a temperature upper or equal to 1000° C., the hot blast including oxygen (6), recovering the blast furnace top gas to extract hydrogen to produce an H2-rich stream (13) including more than 90% v of hydrogen and an H2-lean stream (12 an injecting the H2-rich stream (11) into the blast furnace at the second level of gas injection (3B). Associated network of plants.

The invention is related to an ironmaking method and to the associated ironmaking plant.

### BACKGROUND

In blast furnaces, the conversion of the iron-containing charge (sinter, pellets and iron ore) to cast iron, or hot metal, is conventionally carried out by reduction of the iron oxides by a reducing gas (in particular containing CO, H2 and N2), which is formed by partial combustion of coke and eventually auxiliary reducing agents at the tuyeres located in the bottom part of the blast furnace where air preheated to a temperature between 1000° C. and 1300° C., called hot blast, is injected.

The auxiliary reducing agents that may be injected at the tuyeres to increase the productivity and reduce the costs may be coal in pulverized form, fuel oil, natural gas or other fuels, combined with oxygen enrichment of the hot blast.

The gas recovered in the upper part of the blast furnace, called top gas, mainly consists of CO, CO2, H2 and N2 in respective proportions of 20-28% v, 17-25% v, 1-5% v and 48-55% v. Despite partial use of this gas as fuel in other plants, such as power plants, blast furnace remains a significant producer of CO2.

### SUMMARY OF THE INVENTION

In view of the considerable increase in the concentration of CO2 in the atmosphere since the beginning of the last century and the subsequent greenhouse effect, it is essential to reduce emissions of CO2 where it is produced in a large quantity, and therefore in particular at blast furnaces.

For this purpose, during the last 50 years, the consumption of reducing agents in the blast furnace has been reduced by half so that, at present, in blast furnaces of conventional configuration, the consumption of carbon has reached a low limit linked to the laws of thermodynamics.

One solution considered to further reduce this carbon-based reductants consumption and thus to reduce the CO2 footprint of the blast furnace ironmaking production is to capture the top gas, remove CO2 and reinject it into the blast furnace shaft, which is a level above the usual tuyere injection level of the hot blast. However, with this solution the reductant consumption reduction remains below 30% compared to the production in a conventional blast furnace (no top gas recycling) according to numerous calculations and trials performed. In terms of global CO2 footprint, it represents a reduction of less than 20% in volume of emitted CO2.

There is thus a need for an ironmaking method allowing to significantly reduce the carbon-based reductant consumption in the blast furnace.

The present invention provides a method wherein hot metal is produced in at least one blast furnace comprising at least two levels of gas injection and emitting a blast furnace top gas when working, the method comprising at least the steps of charging an iron-containing charge and a first carbon-based reductant into the blast furnace, injecting at the first level a hot blast having a temperature upper or equal to 1000° C., said hot blast comprising oxygen, recovering the blast furnace top gas, extracting hydrogen from the blast furnace top gas to produce an H2-rich stream comprising more than 90% v of hydrogen and an H2-lean stream, injecting the H2-rich stream into the blast furnace at the second level of gas injection.

The method of the invention may also comprise the following optional characteristics considered separately or according to all possible technical combinations:
the first carbon-based reductant comprises coke,
the first carbon-based reductant comprises non-fossil carbon reductant,
the hot blast further comprises at least one second carbon-based reductant,
the second carbon-based reductant comprises non-fossil carbon reductant,
hydrogen produced in a hydrogen production step is added to the H2-rich stream before its injection into the blast furnace,
the hydrogen production step is a water decomposition step which produces hydrogen and oxygen,
the hot blast comprises oxygen produced in the water decomposition step,
the water decomposition step is an electrolysis reaction,
the electrolysis reaction is powered by renewable energy,
the H2-rich stream is injected into the blast furnace at a temperature from 750° C. to 1100° C.,
from 200 Nm3 to 700 Nm3 of hydrogen are injected into the blast furnace per ton of hot metal to be produced,
more than 50% in volume of the hydrogen injected into the blast furnace is hydrogen extracted from the blast furnace top-gas,
hydrogen extracted from a reduction top gas of a direct reduced iron production step is added to the H2-rich stream before its injection into the blast furnace.

The invention is also related to a network of plants comprising at least one blast furnace producing hot metal and emitting a blast furnace top gas, said blast furnace comprising first and second gas injection means respectively located at two different levels over the height of the blast furnace, the first injection means being designed to inject into the blast furnace a hot blast having a temperature upper or equal to 1000° C., said hot blast comprising oxygen, a gas recovery and treatment device able to capture the blast furnace top gas and to extract hydrogen from said blast furnace top gas so as to produce an H2-rich stream and an H2-lean stream, the second injection means being designed to inject into the blast furnace the H2-rich stream.

The network of plants according to the invention may also comprise the following optional characteristics considered separately or according to all possible technical combinations:
the plant further comprises a hydrogen production plant and a hydrogen gas line allowing to mix the produced hydrogen in the hydrogen production plant with the H2-rich stream before its injection into the blast furnace through the second injection means,
the hydrogen production plant is a water decomposition plant producing hydrogen and oxygen,
the plant further comprises an oxygen gas line allowing to inject the produced oxygen with the hot blast before its injection into the blast furnace through the first injection means,
the plant further comprises a direct reduction furnace producing direct reduced iron and a reduction top gas, a second gas recovery and treatment device able to capture the reduction top gas and to extract hydrogen from said reduction top gas so as to produce a direct reduction H2 stream, mixing means allowing to mix said direct reduction H2 stream with the H2-rich stream before its injection into the blast furnace.

### BRIEF DESCRIPTION OF THE DRAWINGS

Other characteristics and advantages of the invention will emerge clearly from the description of it that is given below by way of an indication and which is in no way restrictive, with reference to the appended figures in which:

FIG. 1 illustrates an ironmaking plant allowing to perform a method according to one embodiment of the invention

FIG. 2 illustrates an ironmaking plant allowing to perform a method according to a second embodiment of the invention

FIG. 3 illustrates an ironmaking plant allowing to perform a method according to a third embodiment of the invention

### DETAILED DESCRIPTION

First, it is noted that on the figures, the same references designate the same elements regardless of the figure on which they feature and regardless of the shape of these elements. Similarly, should elements not be specifically referenced in one of the figures, their references may be easily found by referring to another figure.

It is also noted that the figures represent mainly one embodiment of the object of the invention but other embodiments which correspond to the definition of the invention may exist. Elements in the figures are illustration and may not have been drawn to scale.

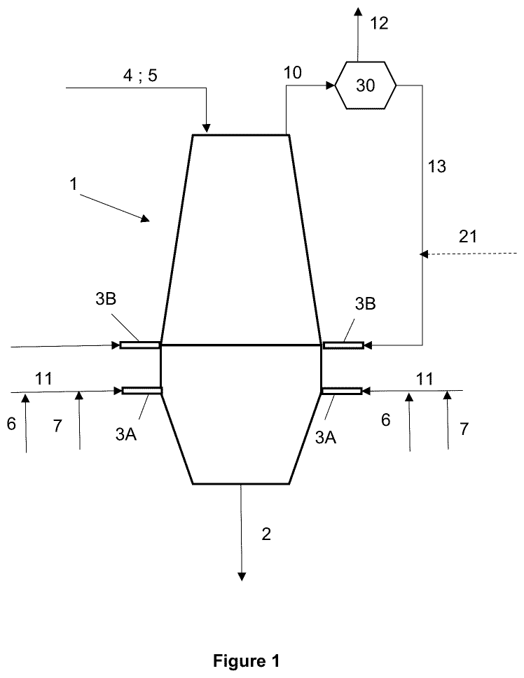

FIG. 1 illustrates an ironmaking plant allowing to perform a method according to one embodiment of the invention. This plant comprises at least one blast furnace 1 wherein an iron-containing charge 4 such as sintered ore, pellets, iron ore is loaded together with a first carbon-based reductant 5 into the throat of the blast furnace 1. This first-carbon based reductant may be coke but is preferentially a non-fossil-based carbon reductant such as biochar or biocoal or waste plastics.

By biochar or biocoal it is meant a charcoal that is produced by pyrolysis of biomass in the absence of oxygen. Biomass is renewable organic material that comes from plants and animals. Biomass sources for energy include notably wood and wood processing wastes—firewood, wood pellets, and wood chips, lumber and furniture mill sawdust and waste, and black liquor from pulp and paper mills, agricultural crops and waste materials—corn, soybeans, sugar cane, switchgrass, woody plants, and algae, and crop and food processing residues, biogenic materials in municipal solid waste—paper, cotton, and wool products, and food, yard, and wood wastes and animal manure and human sewage.

The iron-containing charge 4 is converted to hot metal by reduction of the iron oxides. According to the invention this reduction is performed thanks to three inputs, first one being the injection of the first carbon-based reductant 5, second one being the injection of a hot blast 11 at a first level of injection 3A and finally the injection of hydrogen at a second level of gas injection 3B. For clarity sake, references 3A and 3B designate both the level of injection and the associated injection means at the considered level.

It is further noted that even if both gas injection levels 3A and 3B are illustrated as a pair of arrows in the figures it is only for illustration purposes and that these two gas injections are preferentially performed at each respective level around the whole circumference of the blast furnace 1.

The hot blast 11 has a temperature upper or equal to 1000° C., preferentially from 1000° C. to 1300° C., and comprises oxygen 6 and preferably a second carbon-based reductant 7. It is preferentially injected at the commonly known tuyere level located in the bottom part of the blast furnace 1. This second-carbon based reductant 7 is preferentially in pulverized form and may be coal but is preferentially a non-fossil-based carbon reductant such as biochar or biocoal according to previously given description or waste plastics.

In a preferred embodiment the hot blast comprises from 35 to 70 Nm3 of oxygen per ton of hot metal to be produced. While higher levels are possible, adding oxygen into this range allows keeping the hot blast flow rate at a level compatible with a good distribution of the gas in the lower part of the furnace, resulting in a satisfying operation of the blast furnace. The remaining component of the hot blast is air. This oxygen is preferentially mixed to the air before heating. This hot blast allows the combustion of coke at the tuyeres which is then converted into a reducing gas allowing iron ore reduction.

In the method according to the invention there is thus a third input for the reduction of iron. It consists in hydrogen which is injected at a second level 3B of the blast furnace, preferentially at the shaft level which is above the tuyere level. This hydrogen is preferentially injected at a temperature from 750° C. to 1100° C., and more preferentially from 900° C. to 1000° C.

From 200 Nm3 to 700 Nm3 of hydrogen maybe injected per ton of produced hot metal 2. Introduction of this hydrogen allows a partial reduction of the wustite of the ferrous burden at an earlier stage into the furnace and to perform in-situ metallization of the iron charge inside the furnace. Below 200 Nm3/thm, there might be some issues concerning the homogeneous distribution of the reducing gas over the periphery of the blast furnace, leading to disturbances induced by a heterogeneous metallization of the ferrous burden. On the other hand, injecting 700 Nm3/thm of hydrogen is sufficient to convert all the iron oxides of the ferrous burden into metallic iron at the injection level. Injecting hydrogen in excess of 700 Nm3/thm would then bring no further advantage as this hydrogen will not react with iron oxides. It would just contribute to the heating of the blast furnace top gas.

According to the invention this hydrogen comes at least partially from the blast furnace top gas 10. Said top gas 10 is captured at the exit of the blast furnace 1, sent to a gas recovery and treatment device 30 where it is split between a H2-rich stream 11 and a H2-lean stream 12. This H2-rich stream 11 preferentially comprises more than 90% in volume of H2 and is then injected into the blast furnace 1 at the second level of injection 3B. The H2-lean stream may be sent to further gas treatment device, for example to remove CO2 and store it or use it for chemicals production. Recovering and injecting H2 coming from the top gas allows to reduce the need for an external source of hydrogen and thus to reduce the operating costs of the process. The inventors have discovered that even if the top gas 10 contains a low amount of hydrogen it is already sufficient to divide by more than two the required amount of external hydrogen for a given hydrogen injection rate into the shaft of the furnace, hence for a given reduction of the CO2 emissions of the installation.

As a matter of illustration, the top gas 10 may comprise between 15 and 25% v of CO, between 20 and 30% v of CO2, between 2 and 32% of H2 and more than 30% v of N2. This composition varies broadly according to the amount of hydrogen injected. In a preferred embodiment the H2-lean stream comprises less than 0.1% v of H2.

The gas recovery and treatment unit 30 may comprise at least one compressor, an impurity removal device such as hydrolysis bed or a ZnO bed, a CO2 and/or CO removal device such as a PSA or VPSA and a PSA dedicated to H2 recovery.

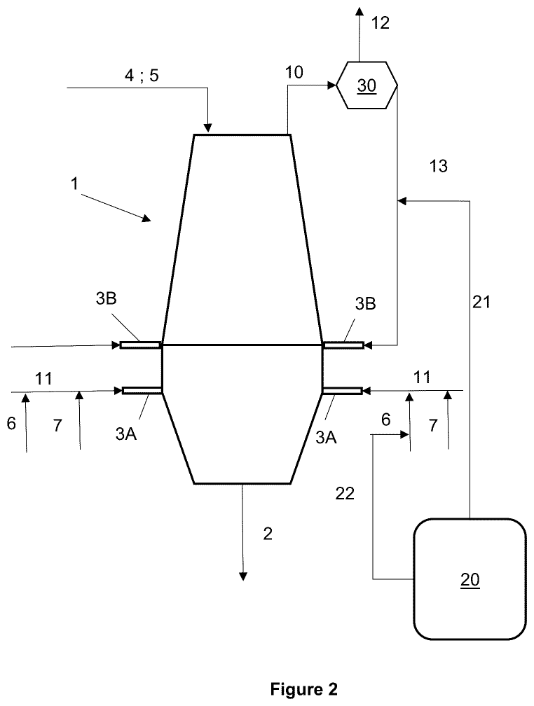

In a preferred embodiment as illustrated in FIG. 2 hydrogen 21 produced in a hydrogen production plant 20 is added to the H2-rich stream 13 before its injection into the blast furnace 1. This allows a further decrease in the need for carbon-based reductants addition. Preferably less than 50% in volume of the total amount of hydrogen injected by the second injection means 3B comes from the hydrogen production plant 20.

In a most preferred embodiment, the hydrogen production plant 20 is a water decomposition plant which produces hydrogen 21 and oxygen 22 from water, by electrolysis for example. As illustrated in FIG. 2 said produced oxygen 22 may be used as source of oxygen 6 for the hot blast 11. This allows reduction of the operating costs of the whole plant as there is no or reduced need for external purchase of oxygen.

In a most preferred embodiment, the hydrogen production plant 20 is powered by renewable energy which is defined as energy that is collected from renewable resources, which are naturally replenished on a human timescale, including sources like sunlight, wind, rain, tides, waves, and geothermal heat. In some embodiments, the use of electricity coming from nuclear sources can be used as it is not emitting CO2 to be produced.

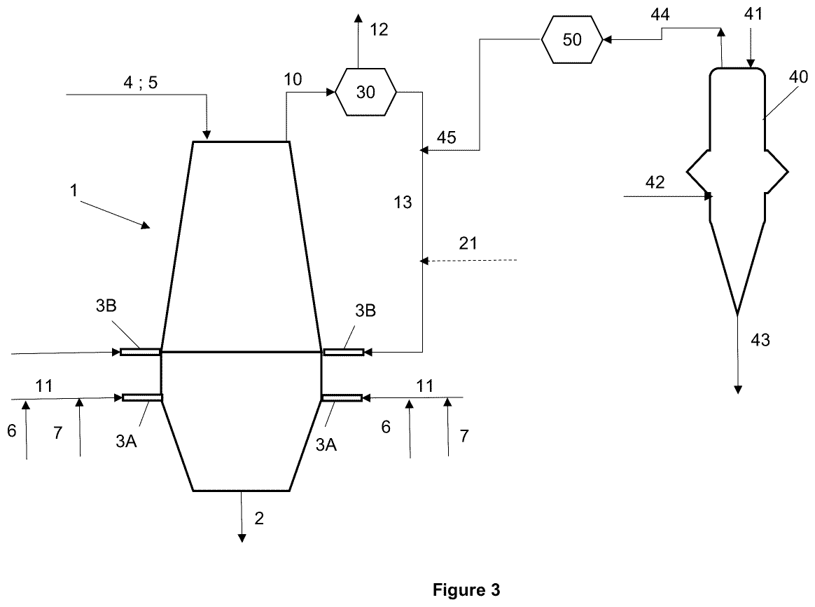

In another embodiment as illustrated in FIG. 3, the plant further comprises a direct reduction furnace 40. In working mode, iron oxide ores and pellets 41 containing around 30% by weight of oxygen are charged to the top of the furnace 40 and are allowed to descend, by gravity, through a reducing gas 42. This reducing gas 42 is injected into the furnace 40 so as to flow counter-current from the charged oxidised iron. Oxygen contained in ores and pellets is removed in stepwise reduction of iron oxides in counter-current reaction between gases and oxide. Oxidant content of gas is increasing while gas is moving to the top of the furnace. Reduced iron, also called DRI product 43 exits at the bottom of the furnace 40 while a reduction top gas 44 exits at the top of the furnace 40. This reduction top gas 44 is captured and treated in a second gas treatment unit 50 so as to extract hydrogen and mix it with the H2-rich stream 13 at a mixer 45 (shown schematically). Composition of the reduction top gas 44 varies according to the composition of the reducing gas 42 injected into the furnace 40. In a preferred embodiment, the reducing gas 42 comprises more than 90% v of hydrogen, this hydrogen being preferentially green hydrogen.

With the method according to the invention it is possible to reduce the CO2 emitted of at least 35% in volume and even to more than 50% according to the various embodiments described and as compared to the production in a conventional blast furnace (no top gas recycling).

What is claimed is:

1-19. (canceled)

20: A method to produce hot metal in at least one blast furnace, the blast furnace including at least first and second levels of gas injection and emitting a blast furnace top gas when working, the method comprising at least the steps of:
A. charging an iron-containing charge and a first carbon-based reductant into the blast furnace;
B. injecting at the first level a hot blast having a temperature upper or equal to 1000° C., the hot blast including oxygen;
C. recovering the blast furnace top gas;
D. extracting hydrogen from the blast furnace top gas to produce an H2-rich stream including more than 90% v of hydrogen and an H2-lean stream; and
E. injecting the H2-rich stream into the blast furnace at the second level of gas injection.

21: The method as recited in claim 20 wherein the first carbon-based reductant includes coke.

22: The method as recited in claim 20 wherein the first carbon-based reductant includes non-fossil carbon reductant.

23: The method as recited in claim 20 wherein in step B, the hot blast further including at least one second carbon-based reductant.

24: The method as recited in claim 23 wherein the second carbon-based reductant includes non-fossil carbon reductant.

25: The method as recited in claim 20 wherein hydrogen produced in a hydrogen production step is added to the H2-rich stream before injection into the blast furnace.

26: The method as recited in claim 25 wherein the hydrogen production step is a water decomposition step producing hydrogen and oxygen.

27: The method as recited in claim 26 wherein the hot blast includes the oxygen produced in the water decomposition step.

28: The method as recited in claim 26 wherein the water decomposition step is an electrolysis reaction.

29: The method as recited in claim 28 wherein the electrolysis reaction is powered by renewable energy.

30: The method as recited in claim 20 wherein the H2-rich stream is injected into the blast furnace at a temperature from 750° C. to 1100° C.

31: The method as recited in claim 20 wherein from 200 Nm3 to 700 Nm3 of the hydrogen are injected into the blast furnace per ton of hot metal to be produced.

32: The method as recited in claim 30 wherein more than 50% in volume of the hydrogen injected into the blast furnace is hydrogen extracted from the blast furnace top-gas.

33: The method as recited in claim 20 wherein hydrogen extracted from a reduction top gas of a direct reduced iron production step is added to the H2-rich stream before injection into the blast furnace.

34: An ironmaking production plant comprising:
a. at least one blast furnace producing hot metal and emitting a blast furnace top gas, the blast furnace including first and second gas injectors respectively located at two different levels over the height of the blast furnace;
b. the first injector being designed to inject into the blast furnace a hot blast having a temperature upper or equal to 1000° C., the hot blast including oxygen;
c. a gas recovery and treatment device able to capture the blast furnace top gas and to extract hydrogen from said blast furnace top gas so as to produce an H2-rich stream and an H2-lean stream; and
d. the second injector being designed to inject into the blast furnace the H2-rich stream.

35: The ironmaking production plant as recited in claim 34 further comprising a hydrogen production plant and an hydrogen gas line allowing mixing of the produced hydrogen in the hydrogen production plant with the H2-rich stream before injection into the blast furnace through the second injector.

36: The ironmaking production plant as recited in claim 35 wherein the hydrogen production plant is a water decomposition plant producing hydrogen and oxygen.

37: The ironmaking production plant as recited in claim 36 further comprising an oxygen gas line allowing injection of the produced oxygen with the hot blast before injection into the blast furnace through the first injector.

38: The ironmaking production plant as recited in claim 34 further comprising:
e. a direct reduction furnace producing direct reduced iron and a reduction top gas;
f. a second gas recovery and treatment device able to capture the reduction top gas and to extract hydrogen from the reduction top gas so as to produce a direct reduction H2 stream;
a mixer allowing mixing of the direct reduction H2 stream with the H2-rich stream before injection into the blast furnace.
